(19) United States
(12) Patent Application Publication
(10) Pub. No.: US 2024/0089092 A1
(43) Pub. Date: Mar. 14, 2024

(54) QUANTUM-CLASSICAL HYBRID SECURITY SYSTEMS AND METHODS

(71) Applicant: MELANOX TECHNOLOGIES, LTD., YOKNEAM (IL)

(72) Inventors: Tali Septon, Haifa (IL); Elad Mentovich, Tel Aviv (IL); Yonatan Piasetzky, Tel Aviv (IL); Moshe B. Oron, Rehovot (IL); Taylor Lee Patti, Orange, CA (US)

(21) Appl. No.: 18/123,555

(22) Filed: Mar. 20, 2023

(30) Foreign Application Priority Data
Sep. 8, 2022 (IL) 296343

(51) Int. Cl. H04L 9/08; G06N 10/40; H04B 10/70

(52) U.S. Cl. CPC H04L 9/0852; G06N 10/40; H04B 10/70

(57) ABSTRACT

Embodiments are disclosed for providing quantum-classical hybrid security. An example system includes a hybrid quantum-classical transmitter device. The hybrid quantum-classical transmitter device includes a classical transmitter and a quantum transmitter. The classical transmitter is configured to generate data based on a cryptography technique. The classical transmitter is also configured to generate a classical bitstream representation of the data, where the classical bitstream is configured for transmission via an optical communication channel. The quantum transmitter is configured to embed one or more qubits into the classical bitstream to generate a hybrid quantum-classical bitstream for transmission via the optical communication channel.

### CROSS-REFERENCE TO RELATED APPLICATIONS

This application claims priority to Israel Patent Application No. 296343, filed Sep. 8, 2022, the entire contents of which application are hereby incorporated herein by reference.

### TECHNOLOGICAL FIELD

Embodiments of the present invention relate generally to datacenter security using physical layer security and/or cryptography.

### BACKGROUND

Data security is paramount in datacenter environments. The financial cost of a security breach in a datacenter environment can be substantial, especially when certain types of sensitive customer data are exposed. Traditionally, data in a datacenter environment is protected using encryption, network segmentation, and/or firewalls with intrusion prevention systems, which are generally simpler and faster than encryption. However, in the modern hyperscale datacenter, space and workloads are shared among different clients as well as public cloud fabric without physical separation. In order to minimize vulnerabilities in datacenter environments, most if not all segments of a datacenter network are generally configured with encryption. However, traditional encryption techniques have been proven to be vulnerable against a sufficiently powerful quantum computer. With advancements in quantum computers, a datacenter environment that employs traditional encryption techniques that are non-quantum resilient can be susceptible to a quantum computing attack.

### BRIEF SUMMARY

Example embodiments of the present invention relate generally to a system(s), method and apparatus to implement and/or provide a quantum hybrid cryptography security scheme. The details of some embodiments of the subject matter described in this specification are set forth in the accompanying drawings and the description below. Other features, aspects, and advantages of the subject matter will become apparent from the description, the drawings, and the claims.

In an embodiment, a hybrid quantum-classical transmitter device comprises a classical transmitter and a quantum transmitter. The classical transmitter is configured to generate data based on an encoding technique and/or a cryptography technique. The classical transmitter is also configured to generate a classical bitstream representation of the data. The classical bitstream is configured for transmission via an optical communication channel. The quantum transmitter is configured to embed one or more qubits into the classical bitstream to generate a hybrid quantum-classical bitstream for transmission via the optical communication channel. In some embodiments, the quantum transmitter is configured to randomly embed the one or more qubits into the classical bitstream to generate the hybrid quantum-classical bitstream.

In some embodiments, the data is associated with a public key. Additionally, in some embodiments, the classical transmitter is configured to generate the classical bitstream based on the public key.

In some embodiments, the classical transmitter is configured to generate the data based on a quantum-resistant cryptography technique. In some embodiments, the classical transmitter is configured to generate the data based on a post-quantum cryptography technique.

In some embodiments, the quantum transmitter is configured to generate the one or more qubits at a same wavelength as one or more classical bits of the classical bitstream. In some embodiments, the quantum transmitter is configured to generate the one or more qubits at a same polarization as one or more classical bits of the classical bitstream.

In some embodiments, the quantum transmitter is configured to embed the one or more qubits at random positions within the classical bitstream.

In some embodiments, the quantum transmitter is configured to produce one or more of the classical bits of the classical bitstream.

In some embodiments, the quantum transmitter is configured to actively embed the one or more qubits into the classical bitstream using one or more switches, modulation of a laser source, and/or a variable optical attenuator of the quantum transmitter.

In some embodiments, the quantum transmitter is configured to passively embed the one or more qubits into the classical bitstream using a beam combiner.

In another embodiment, a hybrid quantum-classical receiver device comprises a quantum receiver and a classical receiver. The quantum receiver is configured to detect one or more qubits and/or one or more classical bits in the hybrid quantum-classical bitstream. In one or more embodiments, the quantum receiver is configured to detect one or more qubits and/or one or more classical bits in the hybrid quantum-classical bitstream based on a sifted key. The sifted key is determined by applying a key sifting technique to the hybrid quantum-classical bitstream. The classical receiver is configured to detect one or more classical bits in the hybrid quantum-classical bitstream in response to a determination that the sifted key satisfies a defined quality metric.

In some embodiments, the defined quality metric is a defined quantum bit error rate. Additionally, in some embodiments, the classical receiver is configured to detect the one or more classical bits in the hybrid quantum-classical bitstream in response to a determination that the sifted key satisfies the defined quantum bit error rate.

In some embodiments, the hybrid quantum-classical receiver is configured to discard the hybrid quantum-classical bitstream in response to a determination that the sifted key does not satisfy the defined quality metric.

In some embodiments, the hybrid quantum-classical receiver is configured to perform an error correction technique with respect to the one or more classical bits or the one or more qubits in response to the determination that the sifted key satisfies the defined quality metric.

In some embodiments, wherein the hybrid quantum-classical receiver is configured to perform a privacy amplification technique with respect to the one or more classical bits or the one or more qubits in response to the determination that the sifted key satisfies the defined quality metric.

In yet another embodiment, a method is provided. The method provides for generating data for transmission via an optical communication channel. The method also provides for generating a classical bitstream representation of the data. The classical bitstream is configured for transmission via the optical communication channel. The method also provides for embedding one or more qubits into the classical bitstream to generate a hybrid quantum-classical bitstream for transmission via the optical communication channel. Additionally, the method provides for transmitting the hybrid quantum-classical bitstream via the optical communication channel.

In some embodiments, generating the data comprises generating a public key based on a cryptography technique. In some embodiments, generating the data comprises generating the data based on a quantum-resistant cryptography technique.

In some embodiments, the method further provides for generating the one or more qubits at a same wavelength as one or more classical bits of the classical bitstream. In some embodiments, the method further provides for generating the one or more qubits at a same polarization as one or more classical bits of the classical bitstream.

In some embodiments, embedding the one or more qubits into the classical bitstream comprises randomly embedding the one or more qubits into the classical bitstream to generate the hybrid quantum-classical bitstream.

In some embodiments, embedding the one or more qubits into the classical bitstream comprises embedding the one or more qubits at random positions within the classical bitstream.

The above summary is provided merely for purposes of summarizing some example embodiments to provide a basic understanding of some aspects of the present invention. Accordingly, it will be appreciated that the above-described embodiments are merely examples and should not be construed to narrow the scope or spirit of the present invention in any way. It will be appreciated that the scope of the present invention encompasses many potential embodiments in addition to those here summarized, some of which will be further described below.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates an exemplary system that provides quantum hybrid security between two parties utilizing a hybrid quantum-classical transmitter device and a hybrid quantum-classical receiver device, in accordance with one or more embodiments of the present disclosure;

FIG. 2 illustrates an exemplary hybrid quantum-classical transmitter device, in accordance with one or more embodiments of the present disclosure;

FIG. 3 illustrates an exemplary hybrid quantum-classical receiver device and one or more purpose-specific components, in accordance with one or more embodiments of the present disclosure;

FIG. 4 illustrates another exemplary system that provides quantum hybrid security between two parties utilizing a hybrid quantum-classical transmitter device and a hybrid quantum-classical receiver device, in accordance with one or more embodiments of the present disclosure;

FIG. 5 illustrates an exemplary hybrid quantum-classical bitstream, in accordance with one or more embodiments of the present disclosure;

FIG. 6 is a flowchart illustrating an example method for providing quantum-classical hybrid security via a transmitter;

FIG. 7 is a flowchart illustrating an example method for providing quantum-classical hybrid security via a receiver; and

FIG. 8 illustrates an example computing system that may be embedded in a network interface card, in accordance with one or more embodiments of the present disclosure.

### DETAILED DESCRIPTION

Example embodiments will now be described more fully hereinafter with reference to the accompanying drawings, in which some, but not all, embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “exemplary” and “example” as may be used herein are not provided to convey any qualitative assessment, but instead merely to convey an illustration of an example. Thus, use of any such terms should not be taken to limit the spirit and scope of embodiments of the present invention.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Data security is paramount in datacenter environments. The financial cost of a security breach in a datacenter environment can be substantial, especially when certain types of sensitive customer data are exposed. Traditionally, data in a datacenter environment is protected using encryption, network segmentation, and/or firewalls with intrusion prevention systems, which are generally simpler and faster than encryption. However, in the modern hyperscale datacenter, space and workloads are shared among different clients as well as public cloud fabric without physical separation. In order to minimize vulnerabilities in datacenter environments, most if not all segments of a datacenter network are generally configured with encryption. Current encryption techniques such as, for example, Rivest-Shamir-Adleman (RSA) encryption of the asymmetric encryption class widely employed for key generation and encryption, generally utilize publicly shared keys and generally employ difficult mathematical problems for calculation of the full key out of the public key. These encryption techniques have been proven to be vulnerable against a sufficiently powerful quantum computer. With advancements in quantum computers, a datacenter environment that employs traditional encryption techniques that are non-quantum resilient can be susceptible to a quantum computing attack. For instance, network eavesdroppers can monitor fiber networks to acquire the public key part and to attempt calculation of the complete key based on tapered data and previous knowledge. For classical computers, this process of decoding would take hundreds of trillion years, resulting in an unpractical decoding task. However, a sufficiently powerful quantum processing unit (QPU) can accomplish this decoding task in a few seconds.

One solution for sharing keys secretly is Quantum Key Distribution (QKD), which can provide information theoretically secure (ITS) transmission of data, and more explicitly the key. QKD is generally resilient against advances in classical computation and/or quantum attacks. However, current solutions provide low secure key rate as compared to data transmission rates in the datacenter, and therefore require a large volume of keys distributed over the network. Moreover, QKD technology generally employs specialized optical components and/or dedicated optical paths. As such, it is generally not economically viable to deploy QKD technology in every network interface controller or every network switch within a datacenter network.

Thus, to address these and/or other issues, systems and/or methods for quantum-classical hybrid security are disclosed herein. For instance, in various embodiments, a quantum-classical hybrid anti-tampering cryptography scheme is provided. In one or more embodiments, a data stream is generated by an encoding technique and/or a cryptography technique. In certain embodiments, the cryptography technique can be a quantum-resistant cryptography technique such as, for example, a post-quantum cryptography (PQC) technique. In certain embodiments, the data stream represents encrypted data and non-encrypted data. For example, the data stream can be associated with a public key or any data to be transmitted between two parties (e.g., a transmitter and a receiver). A classical bitstream representation of the data stream can also be generated and can be shared between a transmitter device and a receiver device via classical communication. In one or more embodiments, quantum bits (qubits) can be embedded within the bitstream to allow detection of eavesdropping by the two parties. For example, qubits can be combined and/or multiplexed with classical bits of the bitstream to provide qubits embedded within the bitstream. In one or more embodiments, qubits can be randomly embedded within the bitstream to allow detection of eavesdropping by the two parties. For example, qubits can be combined and/or multiplexed with classical bits of the bitstream to provide qubits randomly embedded within the bitstream. Accordingly, a quantum channel associated with the bitstream can be employed as a data security mechanism (e.g., an anti-tampering mechanism).

In one or more embodiments, a quantum-classical bitstream is produced and transmitted by a transmitter device. The quantum-classical bitstream may contain public key data employed for encryption. Additionally, a quantum receiver device can detect one or more qubits and/or one or more classical bits of the quantum-classical bitstream. A classical receiver device can additionally or alternatively detect one or more of classical bits of the quantum-classical bitstream.

In various embodiments, a quantum bit error rate (QBER) measurement or another type of quantum information measurement can be performed at the receiver device to detect eavesdropping. The bitstream with the qubits and the classical bits can be transferred on the same optical fiber. Additionally, the qubits and the classical bits of the bitstream can be configured with the same wavelength and/or polarization (e.g., non-binding polarization) to facilitate transfer of the qubits and the classical bits via the same optical fiber and to increase security of the bitstream. In an embodiment, a hybrid quantum-classical transmitter can include a classical transmitter and a quantum transmitter to provide for combining and/or multiplexing qubits with classical bits of a bitstream. Additionally, a hybrid quantum-classical receiver can include a classical receiver and a quantum receiver to provide detection and/or processing of qubits and classical bits of the bitstream.

In an embodiment, data and/or a subset of data included in the bitstream can be configured without a key and the bitstream can be employed as a sensor for detection of physical disturbances of the physical optical communication channel (e.g., fiber or free-space) caused by eaves-dropping with an effect quantified through a defined quality metric. In another embodiment, data and/or a subset of data included in the bitstream can include key data represented by one or more qubits and/or one or more classical bits. In yet another embodiment, one or more classical bits of the bitstream can include a key and one or more qubits of the bitstream can be employed to evaluate error caused by eaves-dropping. In yet another embodiment, one or more qubits bits of the bitstream can include a key and one or more classical bits of the bitstream can be employed to evaluate error caused by eaves-dropping.

By employing quantum-classical hybrid security as disclosed herein, improved efficiency for key transfers between a transmitter device and a receiver device can be provided. Additionally, processing bottlenecks between a transmitter device and a receiver device can be minimized by employing quantum-classical hybrid security as disclosed herein. Furthermore, an amount time, a volume of computing resources, and/or complexity of quantum optical hardware employed by a receiver device for detection of qubits and classical bits of a bitstream, a sifting process, and/or post-processing of recorded qubits and classical bits of a bitstream can be reduced. Moreover, a datacenter network with technological benefits such as, for example, improved security (e.g., to provide information-theoretic security for a datacenter network, etc.), improved performance, improved efficiency, reduced processing load for a datacenter system, and/or one or more other technological benefits can be provided. Improved utilization of computing resources within a datacenter network can also be provided. Additionally, as compared to conventional datacenter networks, embodiments disclosed herein provide for improved security for a datacenter network, improved performance for a datacenter network, and/or improved efficiency for a datacenter network.

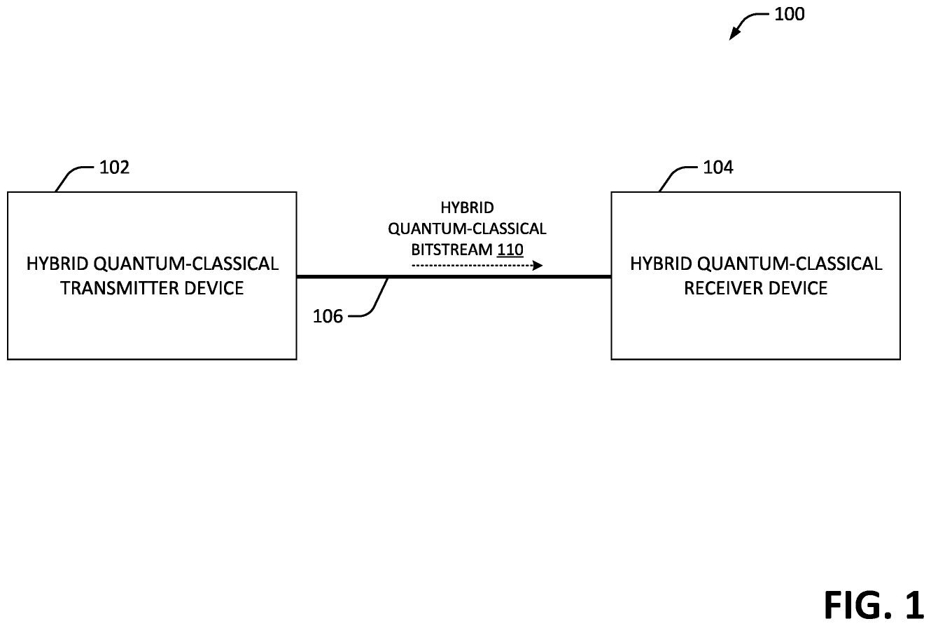

FIG. 1 illustrates a system 100 according to one or more embodiments of the present disclosure. The system 100 can be a communication system that provides quantum-classical hybrid security for data. The system 100 may include a hybrid quantum-classical transmitter device 102 and a hybrid quantum-classical receiver device 104. In various embodiments, the hybrid quantum-classical transmitter device 102 can include a classical transmitter and a quantum transmitter to provide for combining and/or multiplexing qubits with classical bits to generate a hybrid quantum-classical bitstream 110. Additionally, the hybrid quantum-classical receiver device 104 can include a classical receiver and a quantum receiver to provide detection and/or processing of qubits and classical bits of the hybrid quantum-classical bitstream 110. The hybrid quantum-classical transmitter device 102 can transmit the hybrid quantum-classical bitstream 110 to the hybrid quantum-classical receiver device 104 via a channel 106. The channel 106 can be, for example, a communication channel through which classical bits and/or qubits are transmitted. In an embodiment, the channel 106 is an optical communication channel.

In various embodiments, the hybrid quantum-classical transmitter device 102 can generate data based on one or more encoding techniques and/or one or more cryptography techniques. The one or more cryptography techniques can be one or more quantum-resistant cryptography techniques such as, for example, one or more PQC techniques. The data can be data to be transferred securely via the channel 106. In an embodiment, the data can be a data stream to be transmitted between the hybrid quantum-classical transmitter device 102 and the hybrid quantum-classical receiver device 104. In certain embodiments, the data can be a public key to be transmitted between the hybrid quantum-classical transmitter device 102 and the hybrid quantum-classical receiver device 104. The hybrid quantum-classical transmitter device 102 may also be configured to generate a classical bitstream representation of the data. The classical bitstream may be transmitted via the channel 106 using classical communication. For example, the classical bitstream can include a set of classical bits (e.g., a set of binary bits) associated with classical communication.

Additionally, to provide quantum-classical hybrid security of the data associated with the classical bitstream, the hybrid quantum-classical transmitter device 102 can embed one or more qubits into the classical bitstream to generate the hybrid quantum-classical bitstream 110. For example, the hybrid quantum-classical transmitter device 102 can combine and/or multiplex the one or more qubits with the classical bits of the classical bitstream to provide the hybrid quantum-classical bitstream 110 with qubits within the classical bitstream. In one or more embodiments, to provide quantum-classical hybrid security of the data associated with the classical bitstream, the hybrid quantum-classical transmitter device 102 can randomly embed one or more qubits into the classical bitstream to generate the hybrid quantum-classical bitstream 110. For example, the hybrid quantum-classical transmitter device 102 can combine and/or multiplex the one or more qubits with the classical bits of the classical bitstream to provide the hybrid quantum-classical bitstream 110 with qubits at random positions within the classical bitstream. In one or more embodiments, the hybrid quantum-classical transmitter device 102 can generate the one or more qubits at a same wavelength as one or more classical bits of the classical bitstream to facilitate transfer of the one or more qubits and the one or more classical bits via the channel 106. Additionally or alternatively, the hybrid quantum-classical transmitter device 102 may generate the one or more qubits at a same polarization as one or more classical bits of the classical bitstream to facilitate transfer of the one or more qubits and the one or more classical bits via the channel 106.

The hybrid quantum-classical transmitter device 102 may actively embed the one or more qubits into the classical bitstream using one or more switches (not shown) included in the hybrid quantum-classical transmitter device 102. Alternatively, the hybrid quantum-classical transmitter device 102 may actively embed the one or more qubits into the classical bitstream using modulation of a laser source of the hybrid quantum-classical transmitter device 102. In another implementation, the hybrid quantum-classical transmitter device 102 may actively embed the one or more qubits into the classical bitstream using a variable optical attenuator of the hybrid quantum-classical transmitter device 102. However, it is to be appreciated that, in certain embodiments, the hybrid quantum-classical transmitter device 102 can actively embed the one or more qubits into the classical bitstream using a different technique and/or a different component of the hybrid quantum-classical transmitter device 102.

After embedding the one or more qubits into the classical bitstream to generate the hybrid quantum-classical bitstream 110, the hybrid quantum-classical transmitter device 102 may transmit the hybrid quantum-classical bitstream 110 to the hybrid quantum-classical receiver device 104 via the channel 106. The hybrid quantum-classical receiver device 104 may be configured to detect the one or more qubits and the set of classical bits in the hybrid quantum-classical bitstream 110. In one or more embodiments, the hybrid quantum-classical receiver device 104 may apply a key sifting technique to the hybrid quantum-classical bitstream 110 to determine a sifted key that can be employed to detect the one or more qubits in the hybrid quantum-classical bitstream 110. Furthermore, the hybrid quantum-classical receiver device 104 may be configured to detect one or more classical bits in the hybrid quantum-classical bitstream 110 in response to a determination that the sifted key satisfies a defined quality metric. The defined quality metric may be, for example, a defined quantum bit error rate (e.g., a QBER measurement threshold) or another type of quantum information measurement criterion.

In certain embodiments, the hybrid quantum-classical receiver device 104 discards the hybrid quantum-classical bitstream 110 in response to a determination that the sifted key does not satisfy the defined quality metric. In certain embodiments, in response to the determination that the sifted key satisfies the defined quality metric, the hybrid quantum-classical transmitter device 102 and/or the hybrid quantum-classical receiver device 104 perform an error correction technique with respect to the one or more classical bits and/or the one or more qubits in the hybrid quantum-classical bitstream 110. Additionally or alternatively, in response to the determination that the sifted key satisfies the defined quality metric, the hybrid quantum-classical transmitter device 102 and/or the hybrid quantum-classical receiver device 104 may perform a privacy amplification technique with respect to the one or more classical bits and/or the one or more qubits in the hybrid quantum-classical bitstream 110. Accordingly, processing bottlenecks between the hybrid quantum-classical transmitter device 102 and the hybrid quantum-classical receiver device 104 can be minimized. Furthermore, an amount of time and/or a number of computing resources employed by the hybrid quantum-classical receiver device 104 for detecting and/or processing data transmitted via the channel 106 may be reduced.

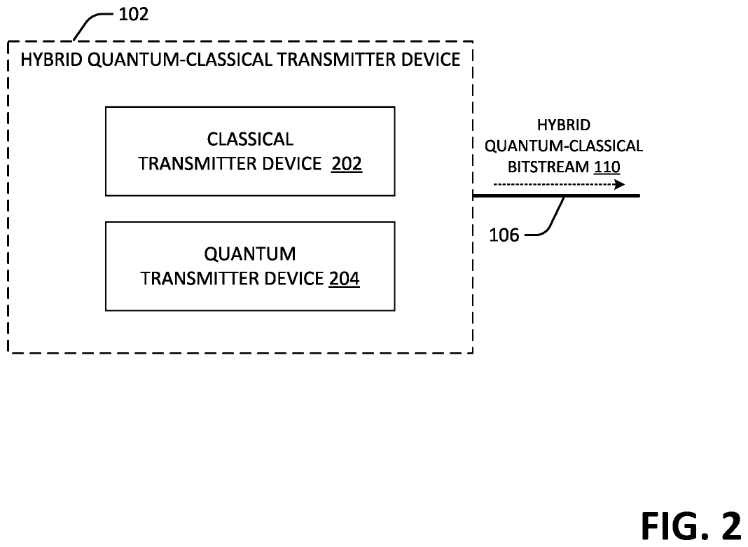

FIG. 2 illustrates the hybrid quantum-classical transmitter device 102 according to one or more embodiments of the present disclosure. In one or more embodiments, the hybrid quantum-classical transmitter device 102 includes a classical transmitter device 202 and a quantum transmitter device 204. The classical transmitter device 202 may be configured to generate the data based on the one or more encoding techniques and/or the one or more cryptography techniques. Furthermore, the classical transmitter device 202 may be configured to generate the classical bitstream representation of the data. The quantum transmitter device 204 may be configured to embed the one or more qubits into the classical bitstream to generate the hybrid quantum-classical bitstream 110. In certain embodiments, the quantum transmitter device 204 may be configured to randomly embed the one or more qubits into the classical bitstream to generate the hybrid quantum-classical bitstream 110. In certain embodiments, the quantum transmitter device 204 may be configured to produce one or more of the classical bits of the classical bitstream.

In certain embodiments, the classical transmitter device 202 includes an equalizer, a clock data recovery unit (CDR), a digital to analog converter, one or more laser driver circuits, a laser, a modulator, and/or optics. In one or more embodiments, an output of the digital to analog converter can be employed to drive a laser driver circuit, such as a VCSEL driver, which drives a laser, such as a VCSEL laser. However, it is to be appreciated that other lasers such as externally modulated lasers (EMLs) and directly modulated lasers (DMLs) may additionally or alternatively be utilized. In certain embodiments, the classical transmitter device 202 includes a Mach-Zehnder modulator (MZM) configured to modulate the classical bitstream representation of the data into an optical signal.

In certain embodiments, the quantum transmitter device 204 includes one or more drivers, a pulsed laser and/or an optical attenuator configured to emit one or more optical pulses associated with photons. Additionally or alternatively, in certain embodiments, the quantum transmitter device 204 includes a quantum single photon source based on a non-linear effect (e.g., spontaneous parametric down-conversion (SPDC) and/or spontaneous parametric four-wave mixing (SP-FWM)) or another type of single photon source. in certain embodiments, the quantum transmitter device 204 includes a quadrature source. In one or more embodiments, the quantum transmitter device 204 can generate one photon or less per bit to embed the one or more qubits into the classical bitstream. Additionally or alternatively, in certain embodiments, the quantum transmitter device 204 includes a modulator configured to set values to the qubits. In one or more embodiments, the quantum transmitter device 204 can modulate the qubits based on a computational basis, a Hadamard basis, and/or mixed states. The quantum transmitter device 204 can also be configured to provide stabilization and/or synchronization with respect to a quantum receiver (e.g., quantum receiver device 304) of the hybrid quantum-classical receiver device 104.

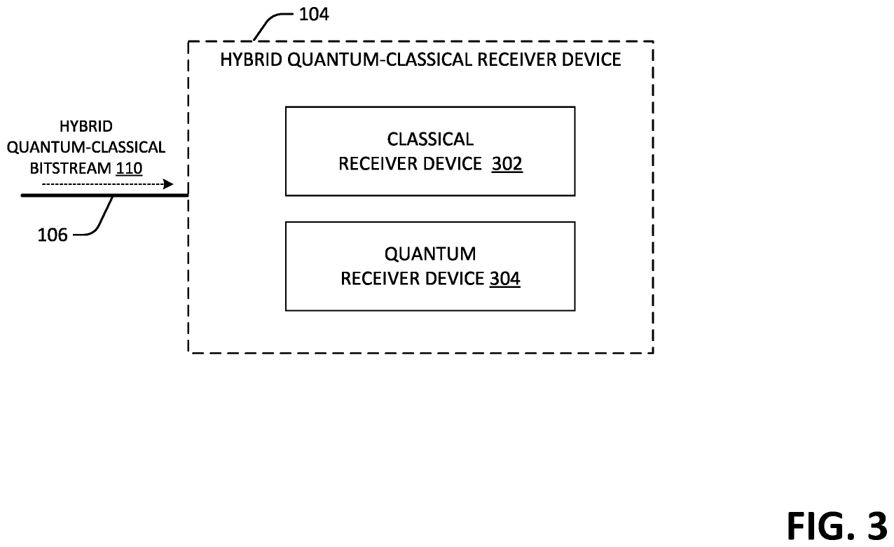

FIG. 3 illustrates the hybrid quantum-classical receiver device 104 according to one or more embodiments of the present disclosure. In one or more embodiments, the hybrid quantum-classical receiver device 104 includes a classical receiver device 302 and a quantum receiver device 304. The quantum receiver device 304 may be configured to apply the key sifting technique to the hybrid quantum-classical bitstream 110 to generate the sifted key. Based on the sifted key, the quantum receiver device 304 may be configured to detect one or more qubits in the hybrid quantum-classical bitstream 110. In certain embodiments, the quantum receiver device 304 includes a single photon detector such as, for example, an avalanche photodiode (APD), a photomultiplier tube (PMT), a superconducting nanowire single photon detector (SNSPD), or another type of photon detector configured to detect one or more qubits in the hybrid quantum-classical bitstream 110. The quantum receiver device 304 can also be configured for de-modulation of a quantum basis (e.g., a computational basis and/or a Hadamard basis). The quantum receiver device 304 can also be configured to provide stabilization and/or synchronization with respect to a quantum transmitter (e.g., quantum transmitter device 204) of the hybrid quantum-classical transmitter device 102.

The classical receiver device 302 may be configured to detect one or more classical bits in the hybrid quantum-classical bitstream 110 in response to a determination that the sifted key satisfies a defined quality metric. In certain embodiments, the classical receiver device 302 can receive input from a transimpedance amplifier (TIA), which receives input from a photodiode chip that converts one or more portions of the hybrid quantum-classical bitstream 110 into an electrical signal. Accordingly, as classical transmission and detection techniques provide high data rates, improved efficiency for data transfers between the hybrid quantum-classical transmitter device 102 and the hybrid quantum-classical receiver device 104 can be provided.

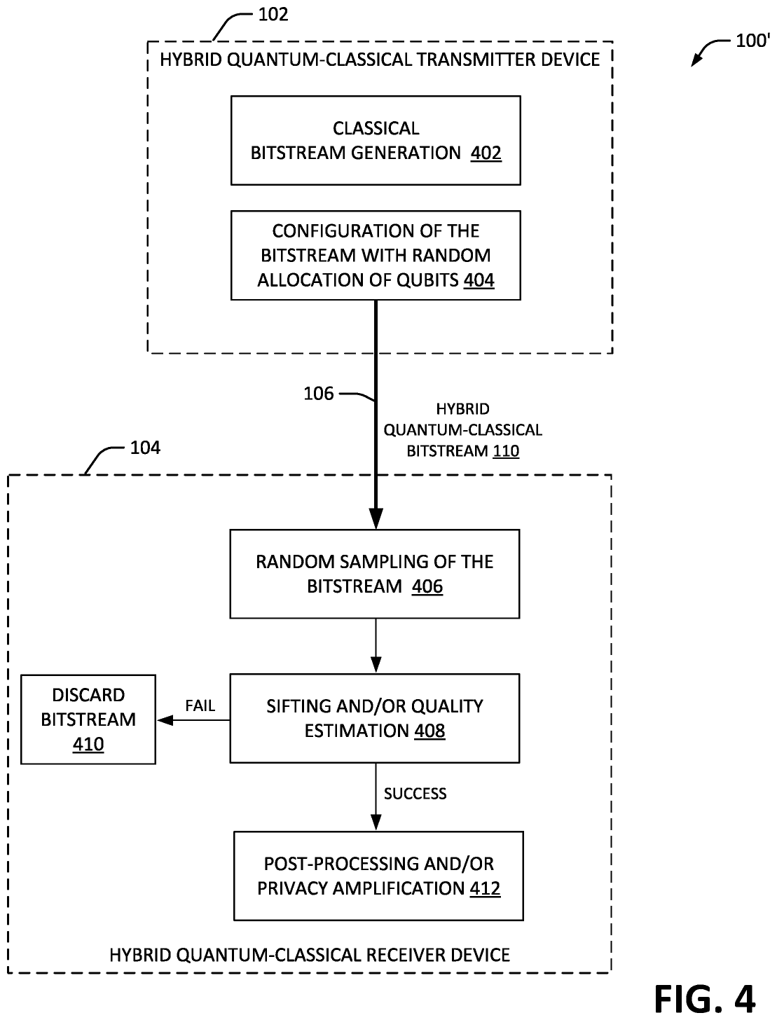

FIG. 4 illustrates a system 100′ according to one or more embodiments of the present disclosure. The system 100′ is an alternate embodiment of the system 100 and illustrates one or more processes performed by the hybrid quantum-classical transmitter device 102 and the hybrid quantum-classical receiver device 104. In one or more embodiments, the hybrid quantum-classical transmitter device 102 such as, for example, the classical transmitter device 202 of the hybrid quantum-classical transmitter device 102, performs a process 402 associated with classical bitstream generation. For example, the process 402 associated with the classical bitstream generation can include at least generating the data based on the one or more cryptography techniques and/or generating the classical bitstream representation of the data. Additionally, in one or more embodiments, the hybrid quantum-classical transmitter device 102 such as, for example, the quantum transmitter device 204 of the hybrid quantum-classical transmitter device 102, performs a process 404 associated with configuration of the bitstream with random allocation of qubits. For example, the process 404 associated with the configuration of the bitstream with the random allocation of the qubits may include at least randomly embedding one or more qubits into the bitstream to generate the hybrid quantum-classical bitstream 110 for transmission to the hybrid quantum-classical receiver device 104 via the channel 106.

In one or more embodiments, the hybrid quantum-classical receiver device 104 such as, for example, the quantum receiver device 304 of the hybrid quantum-classical transmitter device 102, performs a process 406 associated with random sampling of the bitstream. For example, the process 406 associated with the random sampling of the bitstream may include at least using the quantum receiver device 304 to randomly sample the hybrid quantum-classical bitstream 110 for the one or more qubits. The random sampling of the bitstream can be provided actively using, for example, a clock sampling signal. Alternatively, random sampling of the bitstream can be provided passively using, for example, a beam splitter. Additionally, in one or more embodiments, the hybrid quantum-classical receiver device 104, such as, for example, the classical receiver device 302 and/or the quantum receiver device 304, performs a process 408 associated with sifting and/or quality estimation. For example, the process 408 associated with the sifting and/or the quality estimation may include at least applying the key sifting technique to the hybrid quantum-classical bitstream 110 to detect the one or more qubits and/or detecting one or more classical bits in the hybrid quantum-classical bitstream 110 in response to a determination that the sifted key satisfies a defined quality metric.

The sifting and/or the quality estimation can be employed to determine whether or not to disregard the bitstream. For example, in response to a determination that the sifted key does not satisfy the defined quality metric (e.g., the quality estimation with respect to the sifting corresponds to a “fail” state), the hybrid quantum-classical receiver device 104 can perform a process 410 to discard the bitstream. However, in response to a determination that the sifted key satisfies the defined quality metric (e.g., the quality estimation with respect to the sifting corresponds to a “success” state), the hybrid quantum-classical receiver device 104 can perform a process 412 associated with post-processing and/or privacy amplification for the hybrid quantum-classical bitstream 110.

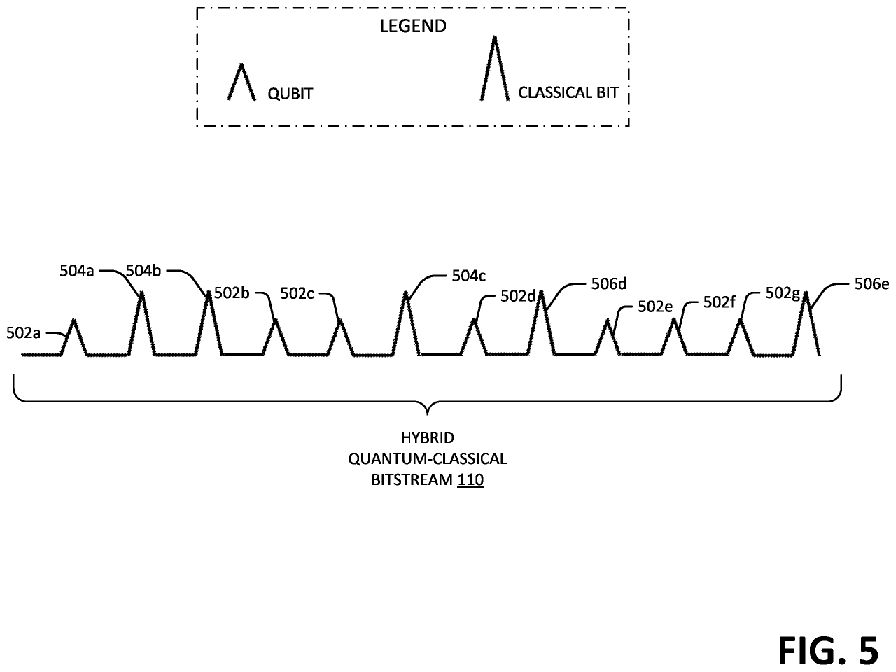

FIG. 5 illustrate an exemplary embodiment of the hybrid quantum-classical bitstream 110 according to one or more embodiments of the present disclosure. As illustrated in FIG. 5, the hybrid quantum-classical bitstream 110 includes a set of classical bits and one or more qubits embedded into the set of classical bits. For instance, in a non-limiting example, the hybrid quantum-classical bitstream 110 can include a qubit 502a, a classical bit 504a, a classical bit 504b, a qubit 502b, a qubit 502c, a classical bit 504c, a qubit 502d, a classical bit 504d, a qubit 502e, a qubit 502f, a qubit 502g, and a classical bit 504e. In certain embodiments, the qubits 502a-g can be randomly embedded within the classical bits 506a-e. For example, the qubit 502d can be embedded between the classical bit 504c and the classical bit 504d. In one or more embodiments, the qubits 502a-g can be embedded (e.g., randomly embedded) within the classical bits 506a-e to allow detection of an eavesdropping device to provide improved data security for the classical bits 506a-e.

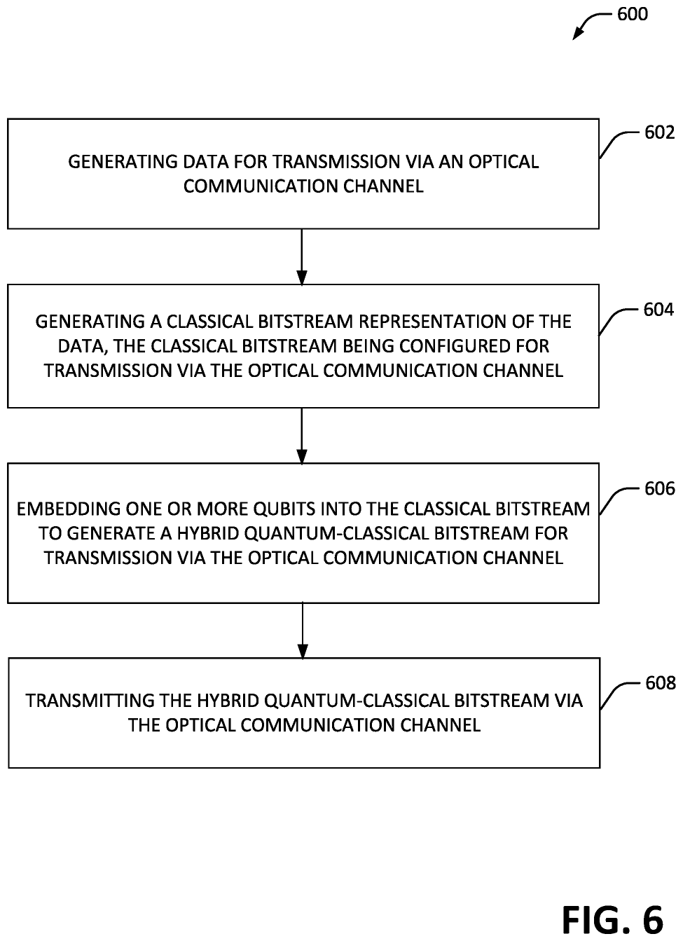

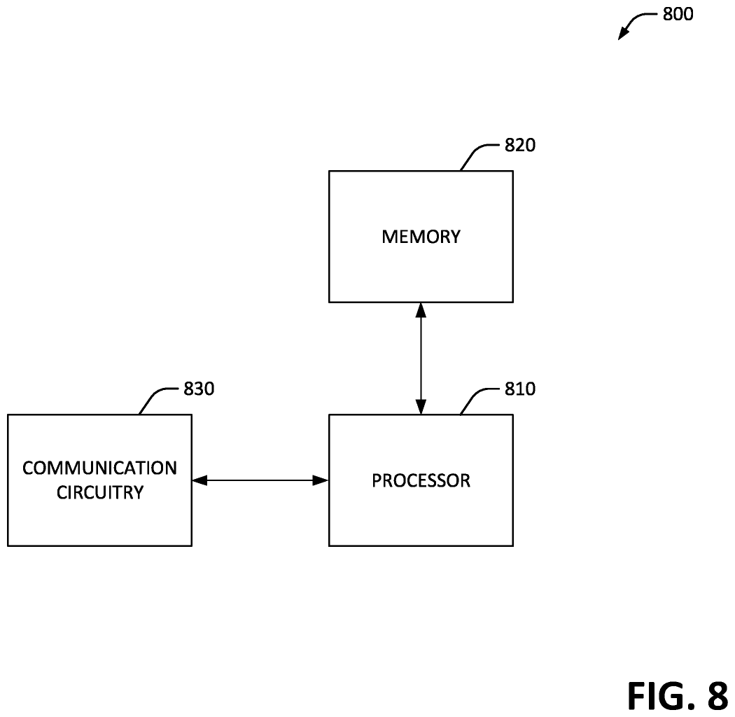

FIG. 6 is a flowchart illustrating an example method for providing quantum-classical hybrid security via a transmitter in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments, additional optional operations may also be included. It should be appreciated that each of the modifications, optional additions, or amplifications described herein may be included with the operations herein either alone or in combination with any others among the features described herein. The operations illustrated in FIG. 6 may, for example, be performed by an example computing system 800 (shown in FIG. 8) that is embedded in a transmitter (e.g., the hybrid quantum-classical transmitter device 102), a processor, an optical transceiver, a switch, and/or another type of network device. In some embodiments, the computing system 800 is a firmware computing system embedded in a transmitter (e.g., the hybrid quantum-classical transmitter device 102), a processor, an optical transceiver, a switch, and/or another type of network device. In one or more embodiments, one or more of the operations illustrated in FIG. 6 may, for example, be performed by a transmitter (e.g., the hybrid quantum-classical transmitter device 102), a processor, an optical transceiver, a switch, and/or another type of network device.

In one or more embodiments, at operation 602, the computing system 800 generates data for transmission via an optical communication channel. In certain embodiments, generating the data comprises generating a public key based on a cryptography technique such as, for example, a quantum-resistant cryptography technique. In certain embodiments, generating the data additionally or alternatively comprises generating a public key based on an encoding technique. In certain embodiments, generating the data comprises generating encrypted data. In one or more embodiments, at operation 604, the computing system 800 generates a classical bitstream representation of the data, the classical bitstream being configured for transmission via the optical communication channel. In one or more embodiments, at operation 606, the computing system 800 embeds one or more qubits into the classical bitstream to generate a hybrid quantum-classical bitstream for transmission via the optical communication channel. In certain embodiments, the computing system 800 randomly embeds the one or more qubits into the classical bitstream to generate the hybrid quantum-classical bitstream. In certain embodiments, the one or more qubits are generated at a same wavelength as one or more classical bits of the classical bitstream. In certain embodiments, the one or more qubits are generated at a same polarization as one or more classical bits of the classical bitstream. In certain embodiments, embedding the one or more qubits into the classical bitstream comprises embedding the one or more qubits at random positions within the classical bitstream. In one or more embodiments, at operation 608, the computing system 800 transmits the hybrid quantum-classical bitstream via the optical communication channel. In certain embodiments, transmitting comprises transmitting the hybrid quantum-classical bitstream to a hybrid quantum-classical receiver. In certain embodiments, transmitting comprises transmitting the hybrid quantum-classical bitstream via a fiber optic communication channel.

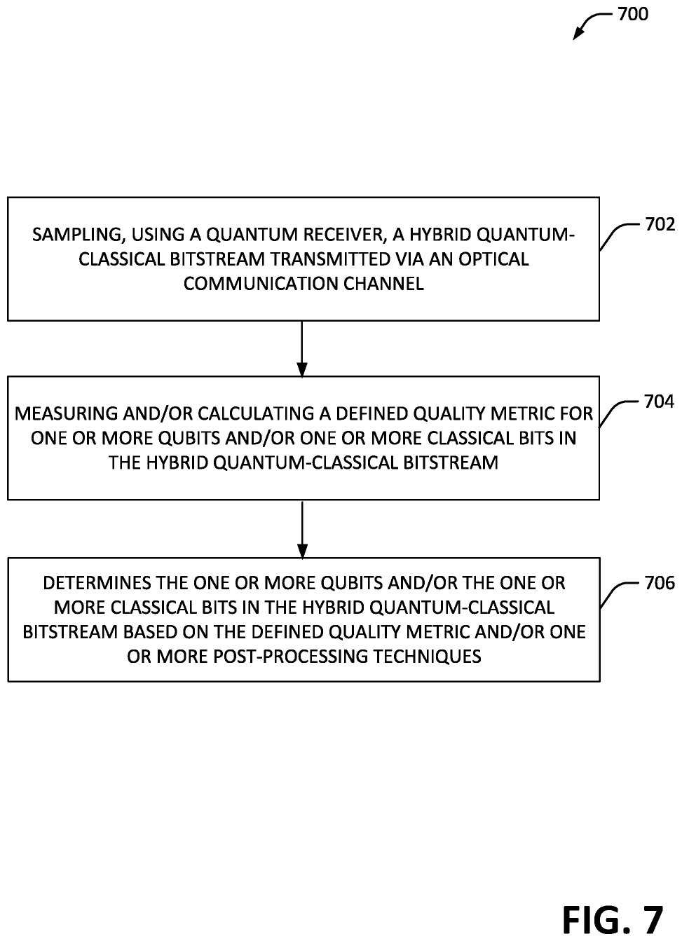

FIG. 7 is a flowchart illustrating an example method for providing quantum-classical hybrid security via a receiver in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments, additional optional operations may also be included. It should be appreciated that each of the modifications, optional additions, or amplifications described herein may be included with the operations herein either alone or in combination with any others among the features described herein. The operations illustrated in FIG. 7 may, for example, be performed by the example computing system 800 (shown in FIG. 8) that is embedded in a receiver (e.g., the hybrid quantum-classical receiver device 104), a processor, an optical transceiver, a switch, and/or another type of network device. In some embodiments, the computing system 800 is a firmware computing system embedded in a receiver (e.g., the hybrid quantum-classical receiver device 104), a processor, an optical transceiver, a switch, and/or another type of network device. In one or more embodiments, one or more of the operations illustrated in FIG. 6 may, for example, be performed by a receiver (e.g., the hybrid quantum-classical receiver device 104), a processor, an optical transceiver, a switch, and/or another type of network device.

In one or more embodiments, at operation 702, the computing system 800 samples, using a hybrid quantum-classical receiver, a hybrid quantum-classical bitstream transmitted via an optical communication channel. The hybrid quantum-classical receiver can include a quantum receiver and a classical receiver. In one or more embodiments, at operation 704, the computing system 800 measures and/or calculates a defined quality metric for one or more qubits and/or one or more classical bits in the hybrid quantum-classical bitstream. In one or more embodiments, at operation 706, the computing system 800 determines the one or more qubits and/or the one or more classical bits in the hybrid quantum-classical bitstream based on the defined quality metric and/or one or more post-processing techniques.

FIG. 8 illustrates the computing system 800 that may be embedded in a transmitter (e.g., the hybrid quantum-classical transmitter device 102), a receiver (e.g., the hybrid quantum-classical receiver device 104), a processor, an optical transceiver, a switch, and/or another type of network device. In various embodiments, the computing system 800 can be a hardware apparatus. In some cases, the computing system 800 may be a firmware computing system communicatively coupled with, and configured to control, one or more circuit modules in the network interface card. For example, the computing system 800 may be a firmware computing system communicatively coupled with one or more circuit modules. The computing system 800 may include or otherwise be in communication with a processor 810, a memory 820, and communication circuitry 830. In some embodiments, the processor 810 (which may include multiple or co-processors or any other processing circuitry associated with the processor) may be in communication with the memory 820. The memory 820 may comprise non-transitory memory circuitry and may include one or more volatile and/or non-volatile memories. In some examples, the memory 820 may be an electronic storage device (e.g., a computer readable storage medium) configured to store data that may be retrievable by the processor 810. In some examples, the data stored in the memory 620 may include the quantum communication protocol data, quantum computing data, quantum computing algorithm data, or the like for enabling the apparatus to carry out various functions or methods in accordance with embodiments of the present invention, described herein. In one or more embodiments, the processor 810 corresponds to the processor 206 and/or the memory 820 corresponds to the memory 208.

In some examples, the processor 810 may be embodied in a number of different ways. For example, the processor may be embodied as one or more of various hardware processing means such as a microprocessor, a coprocessor, a digital signal processor (DSP), or a processing element with or without an accompanying DSP. The processor 810 may also be embodied in various other processing circuitry including integrated circuits such as, for example, an FPGA, a SoC, a CPU, an array of CPUs, a GPU, an array of GPUs, a hardware accelerator, or a special-purpose embedded electronic chip. Furthermore, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 810 may be configured to execute instructions, such as computer program code or instructions, stored in the memory 820 or otherwise accessible to the processor 810. Alternatively or additionally, the processor 810 may be configured to execute hard-coded functionality. As such, whether configured by hardware or software instructions, or by a combination thereof, the processor 810 may represent a computing entity (e.g., physically embodied in circuitry) configured to perform operations according to an embodiment of the present invention described herein. For example, when the processor 810 is embodied as an FPGA, a SoC, a CPU, an array of CPUs, a GPU, an array of GPUs, a hardware accelerator, a special-purpose embedded electronic chip, or similar, the processor 810 may be configured as hardware for conducting the operations of an embodiment of the invention.

The computing system 800 may optionally also include the communication circuitry 830. The communication circuitry may be any means embodied in either hardware or a combination of hardware and software that is configured to receive and/or transmit data from/to a network and/or any other device or module in communication with the computing system 800. In this regard, the communication interface may include, for example, supporting hardware and/or software for enabling communications. As such, for example, the communication circuitry 830 may include a communication modem and/or other hardware/software for supporting communication via cable, universal serial bus (USB), integrated circuit receiver, or other mechanisms.

Many modifications and other embodiments of the present inventions set forth herein will come to mind to one skilled in the art to which these inventions pertain having the benefit of the teachings presented in the foregoing descriptions and the associated drawings. Therefore, it is to be understood that the present inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A hybrid quantum-classical transmitter device, comprising:
a classical transmitter configured to:
generate data based on a cryptography technique; and
generate a classical bitstream representation of the data, wherein the classical bitstream is configured for transmission via an optical communication channel; and
a quantum transmitter configured to embed one or more qubits into the classical bitstream to generate a hybrid quantum-classical bitstream for transmission via the optical communication channel.

2. The hybrid quantum-classical transmitter device of claim 1, wherein the data is associated with a public key, and wherein the classical transmitter is configured to generate the classical bitstream based on the public key.

3. The hybrid quantum-classical transmitter device of claim 1, wherein the classical transmitter is configured to generate the data based on a quantum-resistant cryptography technique.

4. The hybrid quantum-classical transmitter device of claim 1, wherein the classical transmitter is configured to generate the data based on a post-quantum cryptography technique.

5. The hybrid quantum-classical transmitter device of claim 1, wherein the quantum transmitter is configured to generate the one or more qubits at a same wavelength as one or more classical bits of the classical bitstream.

6. The hybrid quantum-classical transmitter device of claim 1, wherein the quantum transmitter is configured to generate the one or more qubits at a same polarization as one or more classical bits of the classical bitstream.

7. The hybrid quantum-classical transmitter device of claim 1, wherein the quantum transmitter is configured to embed the one or more qubits at random positions within the classical bitstream.

8. The hybrid quantum-classical transmitter device of claim 1, wherein the quantum transmitter is configured to actively embed the one or more qubits into the classical bitstream using one or more switches, modulation of a laser source, or a variable optical attenuator of the quantum transmitter.

9. The hybrid quantum-classical transmitter device of claim 1, wherein the quantum transmitter is configured to passively embed the one or more qubits into the classical bitstream using a beam combiner.

10. A hybrid quantum-classical receiver device, comprising:
a quantum receiver configured to detect one or more qubits in a hybrid quantum-classical bitstream based on a sifted key, wherein the sifted key is determined by applying a key sifting technique to the hybrid quantum-classical bitstream; and
a classical receiver configured to detect one or more classical bits in the hybrid quantum-classical bitstream in response to a determination that the sifted key satisfies a defined quality metric.

11. The hybrid quantum-classical receiver device of claim 20, wherein the defined quality metric is a defined quantum bit error rate, and wherein the classical receiver is configured to detect the one or more classical bits in the hybrid quantum-classical bitstream in response to a determination that the sifted key satisfies the defined quantum bit error rate.

12. The hybrid quantum-classical receiver device of claim 10, wherein the classical receiver is configured to discard the hybrid quantum-classical bitstream in response to a determination that the sifted key does not satisfy the defined quality metric.

13. The hybrid quantum-classical receiver device of claim 10, wherein the classical receiver is configured to perform an error correction technique with respect to the one or more classical bits or the one or more qubits in response to the determination that the sifted key satisfies the defined quality metric.

14. The hybrid quantum-classical receiver device of claim 10, wherein the classical receiver is configured to perform a privacy amplification technique with respect to the one or more classical bits or the one or more qubits in response to the determination that the sifted key satisfies the defined quality metric.

15. A method, comprising:
generating data for transmission via an optical communication channel;
generating a classical bitstream representation of the data, wherein the classical bitstream is configured for transmission via the optical communication channel;
embedding one or more qubits into the classical bitstream to generate a hybrid quantum-classical bitstream for transmission via the optical communication channel; and
transmitting the hybrid quantum-classical bitstream via the optical communication channel.

16. The method of claim 15, wherein generating the data comprises generating a public key based on a cryptography technique.

17. The method of claim 15, wherein generating the data comprises generating the data based on a quantum-resistant cryptography technique.

18. The method of claim 15, further comprising:
generating the one or more qubits at a same wavelength as one or more classical bits of the classical bitstream.

19. The method of claim 15, further comprising:
generating the one or more qubits at a same polarization as one or more classical bits of the classical bitstream.

20. The method of claim 15, wherein embedding the one or more qubits into the classical bitstream comprises embedding the one or more qubits at random positions within the classical bitstream.
